(19) United States
(12) Patent Application Publication
(10) Pub. No.: US 2011/0044045 A1
(43) Pub. Date: Feb. 24, 2011

(54) OLEDs INTEGRATED INTO FAN BLADES

(75) Inventor: James Kostka, Mayfield Heights, OH (US)

Correspondence Address: FAY SHARPE LLP, 1228 Euclid Avenue, 5th Floor, The Halle Building, Cleveland, OH, 44115, US

(73) Assignee: General Electric Company

(21) Appl. No.: 12/543,925

(22) Filed: Aug. 19, 2009

(51) Int. Cl. F21V 33/00; H01J 1/62

(52) U.S. Cl. 362/253; 313/504

(57) ABSTRACT

One or more blades of a fan assembly incorporate a diffuse light source, such as an OLED. One or more light panels are electrically connected together, and the light source mechanically connected to one or more of the blades. Single or multiple colors may be used, and all or select portions of the surface area of the blade can be used to emit light depending on the mounting of the light source.

### BACKGROUND OF THE DISCLOSURE

The present disclosure relates to a fan blade or fan assembly that includes one or more blades, and more particularly to a lighting arrangement associated with an individual blade or blades.

It is already known to provide directional lighting associated with a ceiling fan assembly. These ceiling fans typically have four (4) or more radially extending blades that rotate about a vertical axis. The fan blades are suspended a predetermined distance from the ceiling and the blades are disposed at an angle of attack so that rotation of the blade set in one direction circulate air flow downwardly along the vertical axis, and when the blade set is rotated in the opposite direction, directs the air in the opposite direction. As either a part of the original assembly, or as an add-on feature, the ceiling fan may incorporate one or more downwardly directed lights that are mounted to a stationary portion of the fan housing. These lights are intended to provide desired illumination of the room or area beneath the fan assembly.

There is a desire to provide alternative lighting solutions for ceiling fans, as well as for other fan assemblies. Particularly, an alternative lighting solution that provides a different aesthetic appeal is desired and that can be easily integrated or accommodated in the fan assembly. Accordingly, a need exists for alternative specialty applications that do not adversely impact either the fan or lamp operation.

### SUMMARY OF THE DISCLOSURE

A fan blade for use in an associated fan assembly includes a blade surface having a leading edge and a trailing edge. A diffuse light source is operatively associated with the blade surface for emitting light therefrom.

The light source is preferably an organic light emitting diode (OLED).

The light source emits light from a major surface area of the blade surface, or may only emit light from a selected portion or portions of the blade such as the perimeter or leading and/or trailing edges of the blade.

The light source may be a single color, may be selectively variable, or multiple colors may be provided on the blade.

The light source is selectively removable from and mechanically/electrically fastens to the blade.

The fan assembly with the diffuse light source may comprise one or more blades of the fan assembly. The light source may emit light from a majority or all of the blades, and may also be of the same or different colors.

The light source may be provided on a flexible surface that conforms to a non-planar or curvilinear surface of at least one blade.

Alternative lighting solutions may be provided because of the thin and flexible nature of the diffuse light source.

The OLED light sources may be incorporated into one or more blades or either a ceiling or desktop fan, and the diffuse nature of the light provides a much more soothing aesthetic effect than potential glare or strobe associated with other light sources.

The speed of the fan and the color or colors of the light source also result in interesting lighting effects, e.g. swirls of light, that may be provided in the rotating fan blades.

Still other features and benefits of the present disclosure will become more apparent from reading and understanding the following detailed description.

### BRIEF DESCRIPTION OF THE DRAWINGS

FIG. 1 is a perspective view of a fan assembly, such as a ceiling fan, in which at least one blade incorporates a light source, shown here as multiple OLED panels.

FIG. 2 is a plan view of an individual light source panel dimensioned for receipt in a blade of the fan assembly.

FIG. 3 is an enlarged view of the blade detail in which a portion of the cross-section of an individual fan blade is removable to allow access to install, remove, or replace a light source in the blade.

### DETAILED DESCRIPTION OF THE PREFERRED EMBODIMENTS

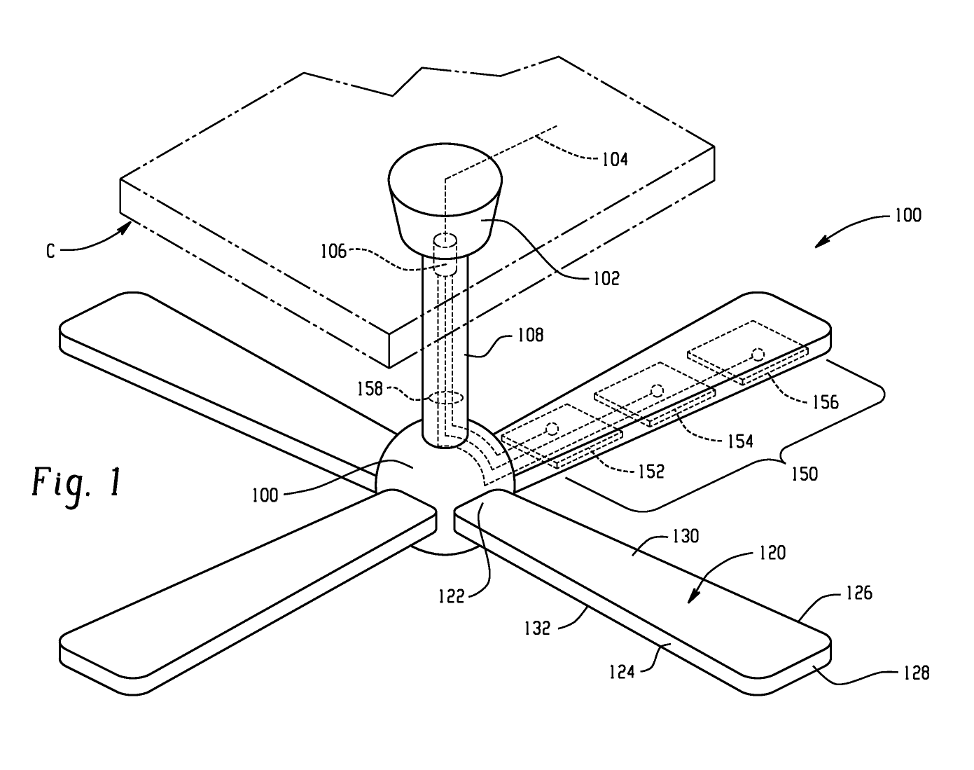

FIG. 1 shows a ceiling fan assembly 100, although it will be appreciated that the present description is also applicable to other fan assemblies such as a floor, pedestal, oscillating, wall mount, portable, desktop, etc. The fan assembly 100 is adapted for mounting from a ceiling C and includes a base or housing 102 secured to the ceiling through conventional fasteners (not shown). The housing 102 also encloses a power source such as an electric motor (not shown). Electrical wiring 104 extends from the ceiling to power the motor and terminates in an electrical connection such as rotary electrical connector 106 that provides for electrical power to the fan blades as will be described below. Shaft 108 extends from the motor in the housing to a hub 110 that rotates with the shaft about a longitudinal or rotational axis of the shaft. Multiple blades, for example four (4) blades as illustrated in FIG. 1, extend radially outward from the hub.

Each blade has a first or radial inner end 122 secured in any suitable manner (e.g., brackets, fasteners, etc.) to the hub 110. The blade first end 122 may be oriented at a predetermined angle or the blade may have a curvature or twist as the blade extends radially outward from the first end. A leading edge 124 and a trailing edge 126 of the blade extend from the first end 122 to a second or outer radial end 128. In addition, it will be appreciated that if the direction of rotation of the fan blade is reversed, then the trailing end will then be referenced as the leading edge and the leading edge 124 will then be referred to as the trailing edge.

Upper surface 130 of the blade has a generally planar conformation in a first preferred embodiment, and likewise the lower surface 132 typically has a generally planar conformation. However, one skilled in the art will appreciate that in some instances one or both of the blade surfaces 130, 132 may have a non-planar conformation, e.g. curvilinear or a twist, from the inner end 122 to the outer end 128, and thus the leading and trailing edges of the blades 124, 126, respectively, may not be linear.

As shown in FIG. 1, there are four (4) blades that are similarly attached to the hub 110 and thus the description of one blade generally applies to the others unless specifically noted otherwise. Since the hub rotates with the shaft 108, the individual blades attached to the hub likewise rotate. A rotary electrical connector 106 is illustrated as one means for providing needed electric power to an integrated lighting source 150, operatively associated with one or more of the fan blades. In this particular arrangement, at least one blade, and preferably more than one blade for purposes of weight balance, incorporates an integral lighting source 150 into the blade of the fan. A thin and flexible light source such as an organic light emitting diode (OLED) is one light source that can preferably be used because of the thin and flexible nature of the OLED light source. In this particular instance, light source 150 is shown as multiple OLED panels 152, 154, 156. Although three OLED panels are illustrated, a greater or lesser number may be used. In addition, the panels are shown as emitting light from lower surface 132 of a particular blade. Light sources could also be incorporated into one or more of the other blades, and different surface area portions of the blade may emit light. For example, only perimeter portions may emit light, or the upper surface rather than lower surface, or all of the surfaces, or only the perimeter outer ends 128 of each blade. Permutations and combinations of such lighting arrangements are not beyond the scope and intent of the present disclosure. Conductive portions such as wires 158 extend from the rotary electrical connector 106 along the shaft into the hub 110. These wires 158 supply the needed electrical power for the light source on one or more of the blades.

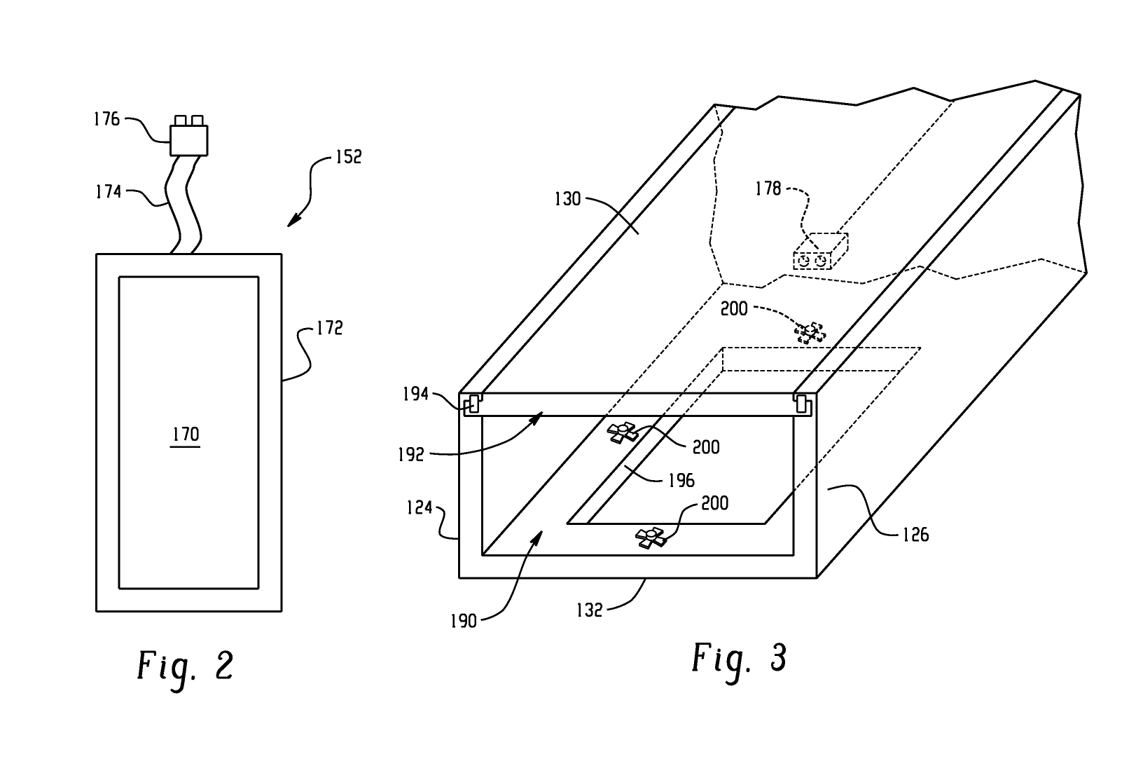

With continued reference to FIG. 1, and additional reference to FIGS. 2 and 3, one preferred arrangement of the detail will be described. The preferred OLED light source is typically a thin film structure formed on a backplane or substrate such as glass or transparent plastic. A light emitting layer of an organic EL material and optional adjacent semiconductor layers are sandwiched between a cathode and an anode. The light emitting organic layer may be multiple sub-layers, or at least a light emitting layer selected from many organic EL materials. These materials emit electromagnetic radiation having a desired range of wavelengths including wavelengths in the visible spectrum for the present purposes. Where white light is desired, it may be necessary to mix blue, green, and red light to produce the white light. Likewise, where flexibility is desired, glass substrates used in some arrangements are not as desirable. Although glass has a low permeability to oxygen and water vapor, and while still being transparent and thus useful in many applications, flexible plastic substrates may alternately be used and incorporate multi-layer barriers to address the resistance to oxygen and water vapor. The particular details of the OLED construction and how the OLED light source operates are deemed to be well known to those skilled in the art so that further description and detail are not required for a full and complete understanding of the present disclosure. For example, reference may be made to commonly owned U.S. Pat. No. 7,015,640 which is assigned to the assignee of the present disclosure.

An individual or single OLED panel 152 is shown in FIG. 2, and its description applies also to other OLED panels 154, 156, or still other panels incorporated in other blades of the fan assembly (FIG. 3). Light emitting surface 170 preferably constitutes a major surface area portion of the panel. An opposite surface (not shown) is typically not a light emitting surface, although such arrangements may be possible without departing from the scope and intent of the present disclosure. Perimeter portions 172 represent the barrier layer that seals the sensitive internal OLED materials from air and moisture. Although the OLED panel is shown as a rectangular conformation, it will also be appreciated that it can adopt different configurations. Electrical leads 174 extend outwardly from the OLED panel for connection to electrical connector 176. The electrical connector is shown as male portion that mechanically and electrically fits the female connector 178 (FIG. 2) received in a cavity of the fan blade. Of course, the male and female portions can be reversed, or other conventional electrical/mechanical connections used such as a snap-fit OLED panel having conductive traces formed therein that electrically connect with corresponding electrical contacts in a pre-wired fixture. One skilled in the art will also appreciate that an associated electronics/driver (not shown) that operatively drives the OLED panel must be accommodated in the ceiling fan assembly at a location that effectively operates the OLED panel but does not adversely impact other features of the fan assembly. For example, the electronics/driver may be positioned in the housing 102 or perhaps incorporated into a separate housing that is mounted in a cavity in the ceiling C to which the housing is secured. Some or all of the electronics could be in the blades as well. OLEDs typically run off of DC in a constant current mode, and there are many types of circuits that could achieve this. In general, two main electronics systems are needed, (i) an AC to DC converter, and (ii) a constant current driver. The constant current driver is quite small, and can fit on a flat flex cable, and so that accommodating at least a portion if not all of the constant current driver into the blades would not be an issue. The AC to DC circuit is larger in size, so it is more likely that at least a portion or all of the AC to DC circuit would be positioned in the housing.

Cavity 190 in the blade is also similarly rectangular in cross-section as evidenced in FIG. 3. At least one of the perimeter walls of the fan blade is preferably slotted so that perimeter wall 192, for example, can be selectively removed from the remainder of the blade. In the preferred embodiment, perimeter wall 192 is connected to a flush radial outer end 128, thereby completely concealing the cavity 190. This enhances the aesthetic appeal of the fan by removing the internal wires and fasteners from view. Latch members 194 are provided to mechanically retain the removable wall 192 in place once the wall is inserted in place. When removed, access is enhanced to the cavity 190 of the fan blade. This allows one or more individual OLED panels 152 to be inserted, connected, replaced, or removed as needed.

Opening 196 is shown in the lower surface 132 of the blade. The opening 196 is substantially identical in dimension to the light emitting portion 170 of the light source panel 152. Thus, the panel is supported along perimeter portion 172 around the opening 196 by the lower surface of the blade. The connector 176 snap-fits to the electrical connector 178. Alternatively, one OLED panel may electrically connect with an adjacent panel, for example, where one connector 176 is attached to the next adjacent OLED panel, and ultimately an end-most OLED panel then electrically connects with connector 178. In addition, mechanical latches 200 are preferably located along perimeter locations of the opening 196 in the blade lower surface to mechanically retain the OLED panel(s) in position within the blade.

Depending on the end use of the light source, colored OLEDs or white OLEDs may be used as the light source. Colored OLEDs might lend better to specialty applications such as lighting in a restaurant, bar, etc. The diffuse nature of the light emitted from the OLEDs is particularly well-suited to this type of application since glare or a strobe effect would not be desired. Also, it would be possible to color tune the perceived light emitted from the blades based on the choice of the OLED panel colors, the brightness level of the individual colored OLED panels, and the speed of the fan. This can enable interesting lighting effects, such as the impression of large swirls of light on the ceiling. The thin, light-weight, and diffuse nature of the flexible OLED light source finds particular application for incorporating into the moving blades.

OLEDs have been developed more recently to offer the benefits of a lower activation voltage and higher brightness in addition to simple manufacture. The capability of a flexible OLED light source also enhances its use in a non-planar application or where curvilinear shapes such as a fan blade may be encountered.

The disclosure has been described with reference to the preferred embodiments. Obviously, modifications and alterations will occur to others upon reading and understanding the preceding detailed description. It is intended that the invention be construed as including all such modifications and alterations.

What is claimed is:

1. A fan blade for use in an associated fan assembly, the fan blade comprising:
a blade surface having a leading edge and a trailing edge; and
a diffuse light source operatively associated with the blade surface for emitting light therefrom.

2. The fan blade of claim 1 wherein the light source is an organic light emitting diode (OLED).

3. The fan blade of claim 1 wherein the light source emits light from substantially an entire area of the blade surface.

4. The fan blade of claim 1 wherein the light source has a single color.

5. The fan blade of claim 4 wherein the light source color is selectively variable.

6. The fan blade of claim 1 wherein the light source is located adjacent a perimeter of the blade surface.

7. The fan blade of claim 1 wherein the light source is selectively removable and includes a mechanical fastener that secures the light source to the blade surface.

8. The fan blade of claim 7 wherein the light source includes an electrical connector adapted to connect to an associated fan assembly.

9. A fan assembly comprising:
a motor that drives a rotary shaft;
at least first and second blades driven by the rotary shaft; and
a light source integrated into at least one of the blades, the light source emitting light from the at least one of the blades.

10. The fan assembly of claim 9 wherein the light source is generally flexible.

11. The fan assembly of claim 9 wherein the light source is provided on each blade.

12. The fan assembly of claim 9 wherein the blades have a curvilinear surface and the light source extends over at least a portion of the curvilinear surface.

13. The fan assembly of claim 9 wherein the light source emits light of a single color.

14. The fan assembly of claim 9 wherein the light source is mounted to the at least one blade with a removable connector.

15. The fan assembly of claim 9 wherein the at least one blade includes discrete multiple light sources.

16. The fan assembly of claim 15 wherein the multiple light sources are the same color.

17. The fan assembly of claim 9 wherein the light source emits light from a surface of the at least one blade.

18. The fan assembly of claim 17 wherein the surface is a lower surface of the at least one blade.

19. The fan assembly of claim 17 wherein the light source emits light from between leading and trailing edges of the at least one blade.

20. A fan assembly comprising:
a motor;
a drive shaft operatively connected to the motor; and
a fan blade assembly including multiple blades extending generally radially outward from a hub that is selectively rotated by the drive shaft about a first axis, at least one of the multiple blades including an organic light emitting diode (OLED) for emitting light therefrom.
